(19) United States
(12) Patent Application Publication
(10) Pub. No.: US 2007/0242814 A1
(43) Pub. Date: Oct. 18, 2007

(54) Mobile CLE media service with cross-platform bookmarking and custom playlists

(76) Inventor: Michael E. Gober, Long Beach, NY (US)

Correspondence Address: MICHAEL GOBER, 69 WEST PENN ST., LONG BEACH, NY, 11561, US

(21) Appl. No.: 11/654,404

(22) Filed: Jan. 16, 2007

Related U.S. Application Data
(60) Provisional application No. 60/759,134, filed on Jan. 13, 2006.

(51) Int. Cl. H04M 11/10

(52) U.S. Cl. 379/101.01

(57) ABSTRACT

The present invention teaches systems and method for accessing content over a variety of devices through a mobile media service. For example, the present invention teaches broadcasting podcasts of all types of content including continuing legal education content over a variety of devices across a variety of platforms. Further, the present invention teaches an integrated system allowing the user to choose a particular presentation from one device and listen and/or watch the presentation on another device. Certain embodiments contemplate providing bookmarking functionality which operate across different platforms, such as a user switching from play on an Internet platform to play on a mobile telephone platform. Other embodiments teach social networking inventions in the context of the mobile media platform.

### CROSS-REFERENCE TO RELATED APPLICATIONS

The present utility application claims priority to Gober's U.S. Provisional Application No. 60/759,134, filed Jan. 13, 2006, and entitled A HOSTED SERVICE SYSTEM, the contents of which are incorporated herein by reference.

### BACKGROUND OF THE INVENTION

The prior art teaches a variety of mechanisms for delivering content to users. For example, a user may purchase content in a tangible form such as CDs, DVDs, or paper. On-demand content is available via on-demand video, or podcasts which are multimedia files and audio programs designed for distribution over the Internet. While solutions continue to improve, the prior art fails to provide users meaningful access to content via ubiquitous devices such as cellular telephones. Still further, the prior art offers little or no flexibility in providing users coherent cross-platform access to content. For example, under current solutions, podcast access is limited to users accessing content at their computers, or downloading content into special devices like iPods and MP3 players.

### SUMMARY OF THE INVENTION

The present invention teaches systems and method for accessing content over a variety of devices through a mobile media service. For example, the present invention teaches systems and methods for receiving podcasts of all types of content including continuing legal education content over a variety of devices across a variety of platforms. Further, the present invention teaches an integrated system allowing the user to choose a particular presentation from one device and listen and/or watch the presentation on another device. Certain embodiments contemplate providing bookmarking functionality which operate across different platforms, such as a user switching from play on an Internet platform to play on a mobile telephone platform. Other embodiments teach social networking inventions in the context of the mobile media platform.

In one embodiment, a method for providing continuing legal education using a telephone is disclosed. The method includes receiving a telephone call from a user. Once a telephone called is received, a greeting is provided. The user is then prompted for a personal identification number (PIN). If the PIN is not verified, the user is again prompted for the PIN. In certain embodiments, if the PIN is not verified after a predetermined number of attempts, the user is disconnected. Once the PIN is verified, control functions are provided to the user. The control functions can vary greatly depending on the desired interface of the system. Menu options are also provided to the user. The menu options include at least one continuing legal education course lecture. The other menu options can correspond to other CLE courses or various other material in alternate embodiments. Once the control functions and menu options are provided to the user, the user is prompted for a menu option. In other embodiments, if the user fails to make a menu choice after a predetermined amount of time, or makes an incorrect menu choice, the menu options are provided to the user again. If the user fails to make a choice the user can be disconnected from the system. When the user makes a menu choice, the lecture corresponding to the menu option is played. During the lecture, the user can insert bookmark at various locations or bookmarks can be inserted automatically. For example, a bookmark can be automatically inserted if the user disconnects from the session. Following the completion of the lecture, additional information regarding service is provided. An option for a new lecture and an option to hang up are also provided. If the first option is chosen, the menu options are once again provided to the user. If the second choice is chosen, the system hangs up thereby disconnecting the user.

In alternate embodiments, the buttons used to correspond to the various control functions can be preset or set by the user. Further, the control functions can differ depending on the specifics of the interface. For example, in one embodiment, the “*” key can fast forward the lecture and the “#” can rewind the lecture. The advancement or retreat of the lecture can be in any increment in time, including 5 second increments. Additional control functions can include “0” for pause, play, and to insert a bookmark.

In another embodiment, a second telephone call is received from a user. Typically, the second telephone call is received after a user disconnects from a previous session. After the telephone call is received, the user is prompted for a personal identification number. If the personal identification number is not verified, the user is again prompted for a valid personal identification number. In certain embodiments, the user can be disconnected from the system after a predetermined number of attempts have been made. If the personal identification number is verified, the user is provided with an option to return to the bookmark left in the previous session. The user is also provided with the option to restart the lecture from the beginning. If the user chooses to return to the bookmark, the lecture begins at substantially the same point of disconnection. If the user chooses to return to the beginning of the lecture, the lecture is replayed in its entirety.

In another embodiment, a hosted service system comprises a centralized server and a continuing legal education lecture. However, in alternate embodiments, the hosted service can comprise a centralized server and any audio program. The centralized server can be capable of receiving a telephone call and providing at least one menu option to a caller. The continuing legal education lecture can be associated with the menu option. The continuing legal education lecture can be played in response to the caller selecting the menu option.

In an alternate embodiment, the continuing legal education lecture or any audio program can be downloaded to a cell phone in response to another menu option. Additionally, the lecture or other audio program can be streamed to the cell phone. Other embodiments contemplate tracking the user for statistical and/or marketing analysis, providing the user with advertisements, and providing the user with an option to buy additional material. Further, the centralized server can be capable of receiving a request from the internet, telephone, and/or any device capable of communicating a request and providing the continuing legal education lecture or any other audio program over the internet, telephone, or any other device capable of receiving the continuing legal education lecture or audio program.

In another embodiment, a method for receiving continuing legal education is disclosed. The method includes calling a centralized server. Once connected to the server, an authorization code is provided. The authorization code can involve providing a personal identification or credit card number. Further, the authorization can be provided from or to the internet. A continuing legal education lecture is then chosen. The session is disconnected after completion of the lecture. In other embodiments, the continuing legal education lecture can be replaced with any audio program.

A method for receiving continuing legal education is disclosed in a further embodiment. The method includes receiving a request for a continuing legal education program. Payment is then verified and the continuing legal education program provided. In additional embodiments, a user can be prompted for a desired format and the continuing legal education program can be provided in the desired format. Moreover, the request can be made over a telephone, the internet, and/or using podcasting. In other embodiments, the continuing legal education lecture can be replaced with any audio program.

A system is disclosed in another embodiment. The system includes a first module, a second module and a third module. The first module can be capable of receiving a telephone request for a CLE program and providing the CLE program over the telephone. The second module can capable of receiving an internet request for a CLE program and providing the CLE program over the internet. The third module can be capable of receiving a podcast request for a CLE program and providing the CLE program by podcasting. Additionally, a request can be received from one module and a CLE program provided by another module. In other embodiments, the continuing legal education lecture can be replaced with any audio program.

The present invention also contemplates a system in which files are downloaded from a centralized server and tracked. In certain embodiments the files are audio files. The tracking can be facilitated in any convenient and/or known manner, including, by way of example a cookie. The tracking device can sync with the server and retrieve tracking information about the client at any convenient time.

In another embodiment, the present invention obviates the need for digital rights management. In such a system, the client does not require any software and/or hardware to facilitate digital rights management because the file, including an audio file, is streamed from the centralized server. Further, the system can employ a digital rights management system to track, gather, and provide information about and to the user.

In further embodiments, audiobooks can be delivered and/or downloaded to any device capable of communication including a cell phone or mp3 players. In other embodiments, the need for digital rights management is obviated because the audiobook is streamed to the device. Many industries would benefit from the system, including cell phone companies because of the number of minutes used to listen to the audio program can increase.

In certain embodiments, multiple users have access to a centralized server. Further, the users have unique access which can be facilitated in a number of ways, including a PIN. The unique access to the system provides the user with completely customized access to the content desired. Further, the unique access and customized use of the system allows the system to track the material accessed by the users. As such, the present invention contemplates targeted advertisements and material specific to the user's preferences.

Moreover, in other embodiments, the invention provides for a user to record notes during a program. In one embodiment, a user hits a number on a touch tone phone to begin recording and another to end the recording. However, in alternate embodiment any device capable of facilitating the recording of a program can be used. The recorded notes can then be sent to the user as an audio file, transcript, or any other convenient and/or known method of communication. In alternate embodiments, the program can include an interactive component, including by way of example, a multiple choice test in order to receive credit and/or for fun. Also, the user can have access to assistance in certain embodiments by pressing an appropriate key.

### BRIEF DESCRIPTION OF THE DRAWINGS

FIG. 1 is a flowchart of a method for providing content such as continuing legal education (CLE) using a telephone.

FIG. 2 is a flowchart of a method for reconnecting to a CLE lecture.

FIG. 3 illustrates a hosted service system.

FIG. 4 is a flowchart of a method for ordering continuing legal education (or any audio program) over the phone.

FIG. 5 is a flowchart of a method for providing continuing legal education (or any audio program) over the phone.

FIG. 6 illustrates a program capable of providing a CLE presentation (or any audio program) over a plurality of devices.

FIG. 7 is a flowchart of a computer implemented method for providing a mobile media service to a plurality of users

FIG. 8 is a flowchart of one possible embodiment of user registration.

FIG. 9 is a flowchart of one possible embodiment for creating customized user playlists.

FIG. 10 is a flowchart of one example method of coherent and integrated cross-platform access to a mobile media service.

FIG. 11 is a flowchart of a method for monetizing a mobile media service.

FIG. 12 is a flowchart of a method for providing social networking services to a user within a mobile media service.

### DETAILED DESCRIPTION OF THE DRAWINGS

The present invention teaches a variety of devices, methods, and other subject matter described herein or apparent to one skilled in the art in light of the present teaching. The present invention further teaches a variety of embodiments, aspects and the like, all distinctive in their own right. The person of skill in the art suitable for the present invention can have a background from electrical engineering, computer science, computer engineering, or the like.

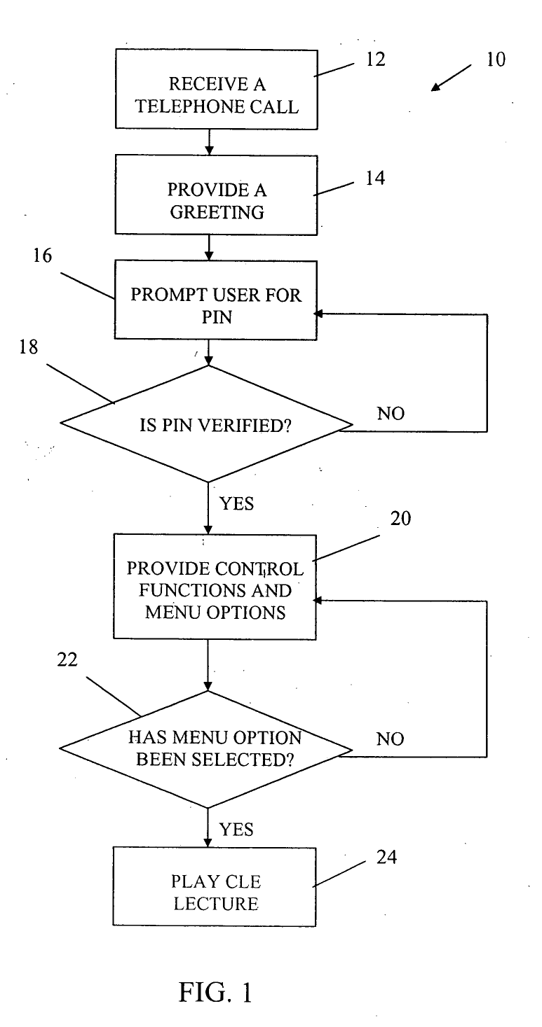

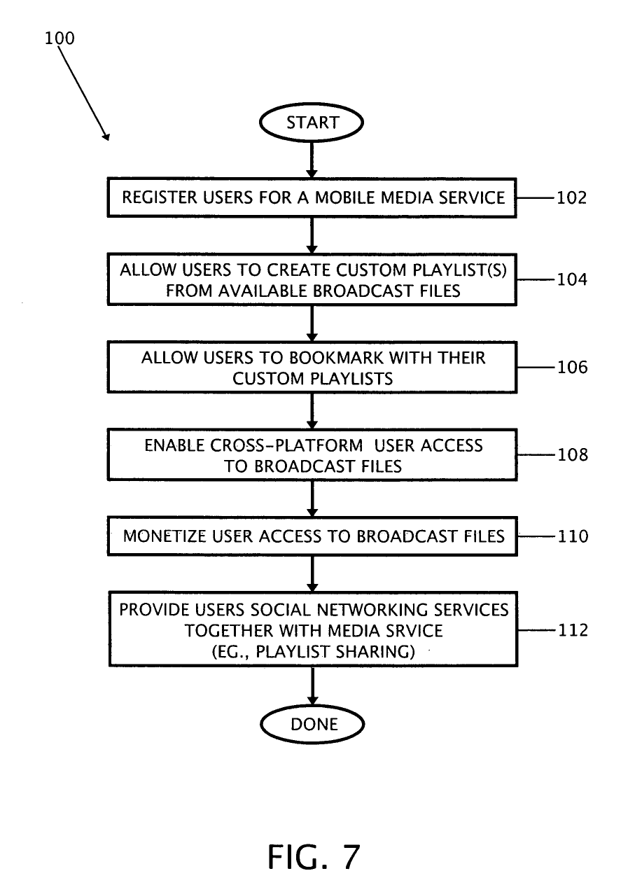

The present invention contemplates a mobile media service operable across multiple platforms and suitable for delivery all forms of content typically in the nature of broadcast information such as audio, video, audiovideo, and podcasts. FIGS. 1-6 teach a variety of embodiments using legal education content as a concrete example. However, as is demonstrated by the various embodiments of FIGS. 7-12, the mobile media server of the present invention is content agnostic.

FIG. 1 illustrates a method 10 for providing continuing legal education (CLE) using a telephone. In the embodiment illustrated, a step 12 receives a telephone call from a user. The telephone call can be made and/or received from any convenient and/or known device capable of making and/or receiving a telephone call. Once a telephone call is received, a step 14 provides a greeting to the user. The greeting can be facilitated in any format, including written and/or verbal, by anything capable of communication, including a human, machine, or a combination of both. Further, the greeting can vary greatly and can be any convenient and/or known response.

A step 16 prompts the user for a personal identification number (PIN). The user can obtain the personal identification number in any format, including written and/or verbal, from any source capable of communication, including a human, machine or a combination of both. Moreover, the PIN can be obtained for free or purchased by the user from the party controlling the continuing legal education program and/or a third party. Once the user inputs the PIN, a step 18 verifies the PIN for authenticity. The PIN can be verified in any convenient and/or known manner capable of verification. If the PIN is not verified, step 16 prompts the user for another PIN. In alternate embodiments, if a predetermined number of invalid PINs is entered, the user can be disconnected from the system.

Once the PIN is verified, a step 20 provides control functions and menu options to the user. The control functions can be provided to the user in any convenient and/or known format capable of communication, including written and/or verbal, from any convenient and/or known source, including a human, machine, or a combination of both. Further, the control functions can manipulate the system in any known and/or convenient manner, including fast forwarding, rewinding, pausing, playing, bookmarking, restarting, ending, increasing/decreasing volume, assigning commands, removing commands and/or changing users, programs, formats, quality, speed, ratings and/or type of lecture. The menu options can be capable of selecting any content available on the system, including CLE lectures.

A step 22 determines whether a menu option has been selected. If not, step 20 provides menu options until a selection has been made. In alternate embodiments, the user can be disconnected if a predetermined amount of time and/or invalid options has been exceeded or a default selection can be made. Once a menu option has been selected, a step 24 plays the corresponding CLE lecture. However, in alternate embodiments, the step 24 can play any program associated with the menu options selected by the user or a default option if none is selected.

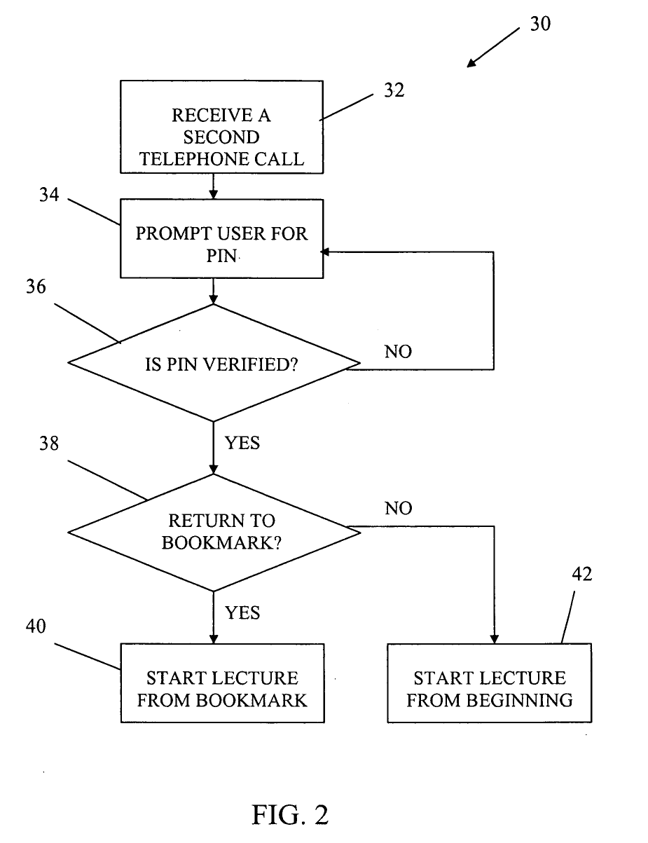

FIG. 2 illustrates a method 30 for reconnecting to a CLE lecture. In the embodiment illustrated, a step 32 receives a second telephone call. The telephone call can be made and/or received from any convenient and/or known device capable of making and/or receiving a telephone call. Once a telephone call is received, a step 34 prompts the user for a personal identification number (PIN). The user can obtain the personal identification number in any format, including written and/or verbal, from any source capable of communication, including a human, machine or a combination of both. Typically, the PIN will be the same as the PIN used in the previous session in order to identify the user and the previous session. However, in alternate embodiments, the PIN can change for security reasons and be capable of the same functionality, or a new PIN can be required. Once the user inputs the PIN, a step 36 verifies the PIN for authenticity. The PIN can be verified in any convenient and/or known manner capable of verification. If the PIN is not verified, step 34 prompts the user for another PIN. In alternate embodiments, if a predetermined number of invalid PINs is entered, the user can be disconnected from the system.

If the PIN is verified, a step 38 determines whether the user wishes to return to a bookmark. The bookmark can be set manually by the user during the previous session or can be set automatically by the system at the point of disconnect. Typically, the bookmark will mark a point in a lecture that the user will return. If the user chooses to return to the bookmark, a step 40 starts the lecture from the bookmark. If the user chooses not to return to the bookmark, the lecture is started from the beginning.

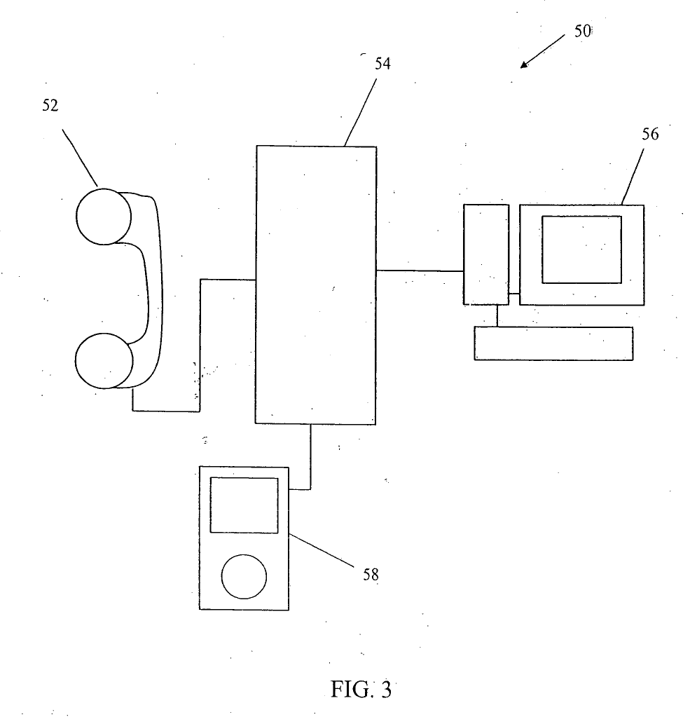

FIG. 3 illustrates a hosted service system 50. The system comprises a centralized server 54, a telephone 52, a computer 56, and a device capable of receiving a podcast 58. In the embodiment illustrated, the telephone 52, the computer 56 and the device capable of receiving a podcast 58 are coupled to the centralized server 54. The centralized server 54 can be capable of receiving a telephone call and providing a CLE program or any other audio program to the caller. The telephone 52 can be a conventional landline telephone, cellular, VOIP or any other device capable of making and/or receiving a communication using telecommunication techniques. The centralized server 54 can also be capable of receiving a request from a computer 56 and providing a CLE program or any other audio program to a computer user. The request can made in any convenient and/or known format capable of being sent from a computer or similar device from any convenient and/or known computing device, including PDA, handheld computer, laptop and/or any device capable of transmitting a communication using computer transmission techniques. Additionally, the centralized server 54 can receive a request from a source, such as a computer, telephone and/or any device capable of communication, and provide the lecture or other audio program to a device capable of receiving podcasts 54, such as an ipod or mp3 player. In additional embodiments, the hosted service can be dynamic in that a request for a CLE program or other audio program can be facilitated by any device capable of communicating with the system and, in response, the system can provide a CLE program or other audio program to any device capable of receiving content from the system.

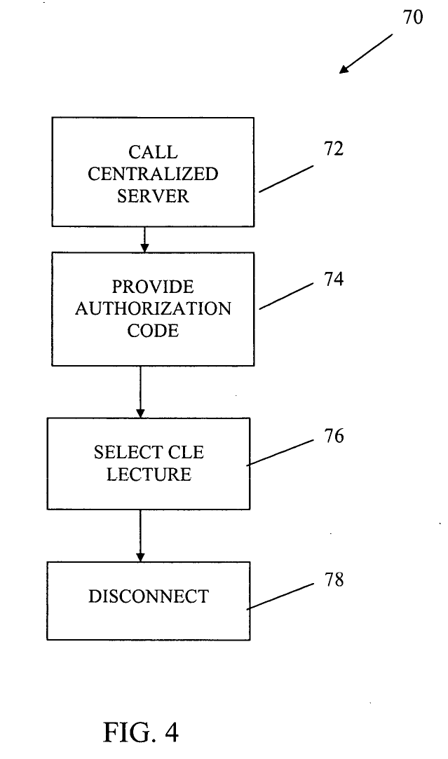

FIG. 4 illustrates a method 70 for ordering continuing legal education (or any audio program) over the phone. In a step 72, a user calls a centralized server. In alternate embodiments, the user can make a request utilizing any device capable of communication, including, by way of example a computer, PDA, laptop, or handheld device. The user provides an authorization code in step 74. The authorization code can be any code capable of allowing a user to access the system. Examples include a personal identification number or a form of payment, such as a credit card number or bank account number. After the user is authorized, the user selects a CLE lecture in step 76. In alternate embodiments, any type of product capable of being transmitted can be selected by the user after authorization. In a step 78, the user is disconnected from the system. Other embodiments replace the continuing legal education lecture with another audio program.

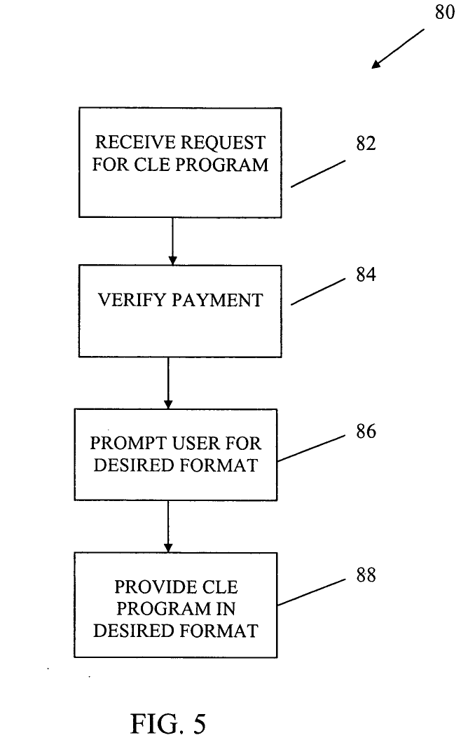

FIG. 5 illustrates a method 80 for providing continuing legal education (or any audio program) over the phone. In a step 82, a centralized server receives a request for a CLE program. In alternate embodiments, the server can receive a request from any device capable of communication, including, by way of example a computer, PDA, laptop, or handheld device. Once the request is received, payment for the CLE program is verified in step 84. Payment can be made in a variety of ways including the purchase of a personal identification number or a direct form of payment such as a credit card or bank account number. After the user is authorized, a step 86 prompts the user for a desired format. The CLE program can be in any convenient and/or known format capable of being played on an intended device. A step 88 provides the CLE program to the user in the desired format. In other embodiments, the continuing legal education lecture can be substituted with any audio program.

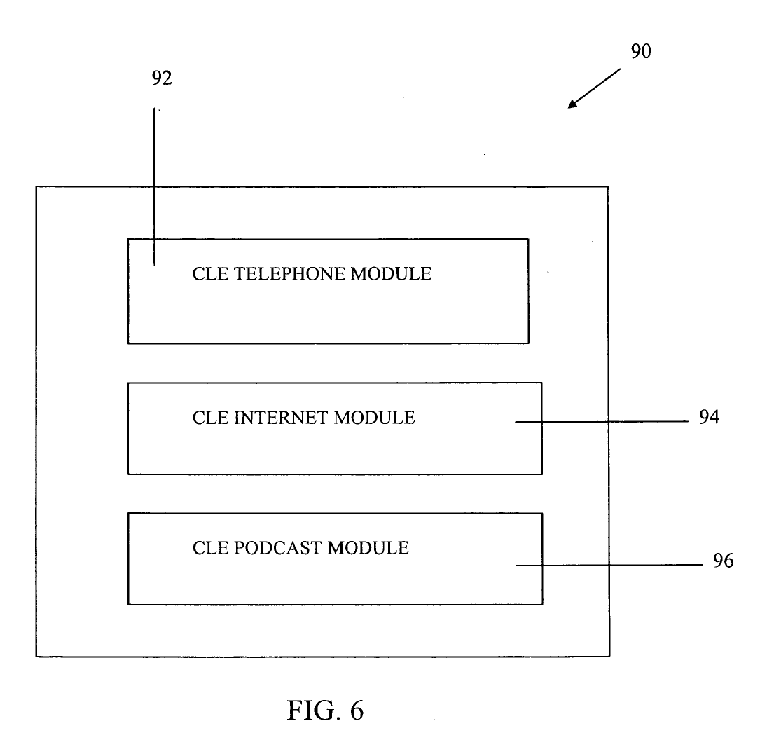

FIG. 6 illustrates a program 90 capable of providing a CLE presentation (or any audio program) over a plurality of devices. In the embodiment illustrated, the program includes a CLE telephone module 92, a CLE internet module 94 and a CLE podcast module 96. The CLE telephone module is capable of receiving a request for and providing a CLE presentation over the telephone. The CLE internet module is capable of receiving a request for and providing a CLE presentation over the internet. The CLE podcast module is capable of receiving a request for and providing a CLE presentation using a device capable of podcasting. In alternate embodiments, a request can be received from one device and provided on another. For example, a user can request a CLE internet presentation over the telephone. In other embodiments, the continuing legal education lecture can be replaced with any audio program.

Turning to FIG. 7, a computer implemented method 100 for providing a mobile media service to a plurality of users will now be described. This aspect of the present invention contemplates providing coherent cross-platform audio and video streaming services to a plurality of users. The different platforms include Internet based and mobile telephone based delivery of services provided in a manner enabling users to access content from both platforms.

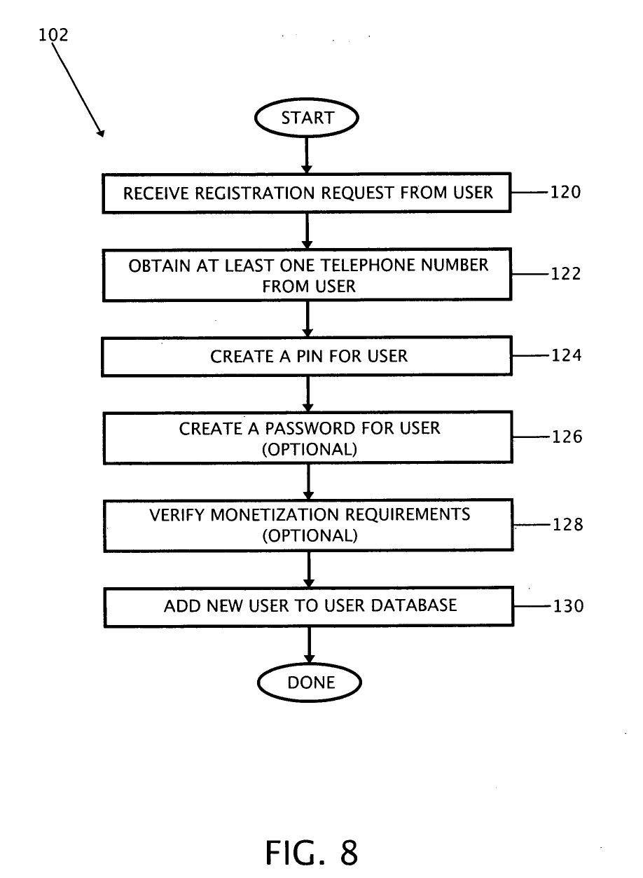

Continuing on with the description of FIG. 7, the method 100 begins in a start block by performing any necessary initialization steps. This could include assembling content in the form of a plurality of broadcast files. A registration step 102 registers a plurality of users for the mobile media service. The registration process may be accomplished through a web interface, a telephone interface, or through any other suitable process. In certain embodiments, a user profile is created in a database including a telephone number associated with the user, a personal identification number (PIN) for each user, and other personal information as desired or necessary for the specific application. One embodiment of registration step 102 is described in more detail below with reference to FIG. 8.

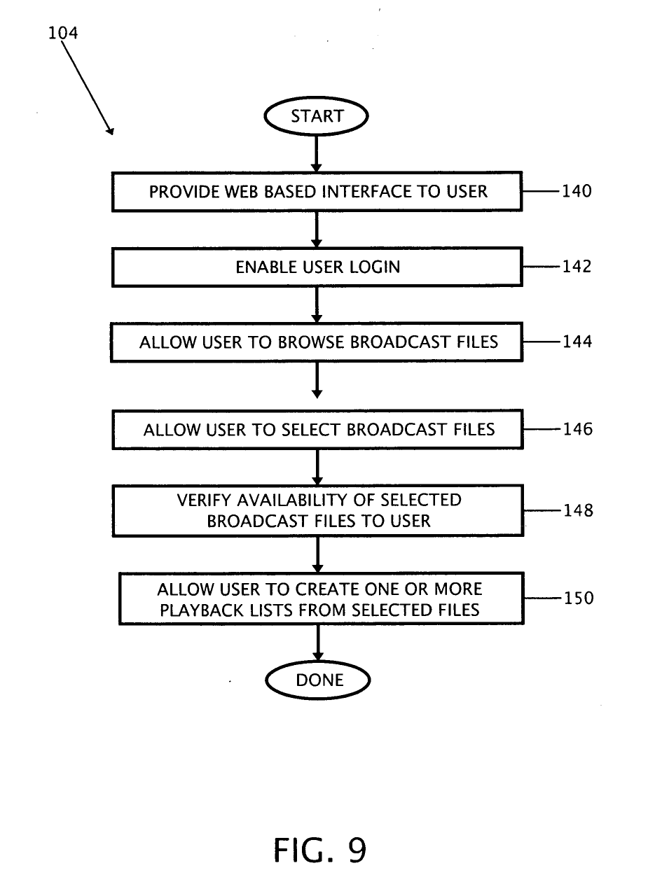

Continuing the description of FIG. 7, a playlist customization step 104 allows users to create one or more custom playlists from the broadcast files available through the mobile media service. The broadcast files may include audio files, video files, audiovideo files, podcasts, text files, and any other suitable media file. That is, unless otherwise noted, broadcast files and/or podcasts as described herein are intended to include all media files suitable for delivery over any of the various platforms described herein. Once created, the custom playlists are available for access by the user through the various platforms (e.g., mobile, Internet) supported by the mobile media service. The playlist customization step 104 may be implemented through a variety of techniques such as a web based portal, a mobile telephone portal, and a call in process. One web based embodiment of the playlist customization step 104 is described below in more detail with reference to FIG. 9.

With further reference to FIG. 7, a bookmarking process 106 allows users to bookmark points within broadcast files which the users have selected for play. The bookmarks set a predefined mark where a user may return to play the broadcast file at a later time. These bookmarks may be inserted manually by the user through any suitable mechanism such as a touchkey command on a mobile telephone, or a selection command through the web based interface.

In some embodiments, perhaps based on a user profile setting, a bookmark may be automatically created anytime the user terminates play of the associated broadcast file, or disconnects from the mobile media service. This allows the user to easily begin play of the broadcast file where the user last left off. In certain embodiments, the bookmarks are available across different platforms. For example, a user may begin a broadcast while working at their desktop computer through a web browser, terminate play of the broadcast, and then pick up the broadcast where they left off by logging into the mobile media server through the user's mobile telephone.

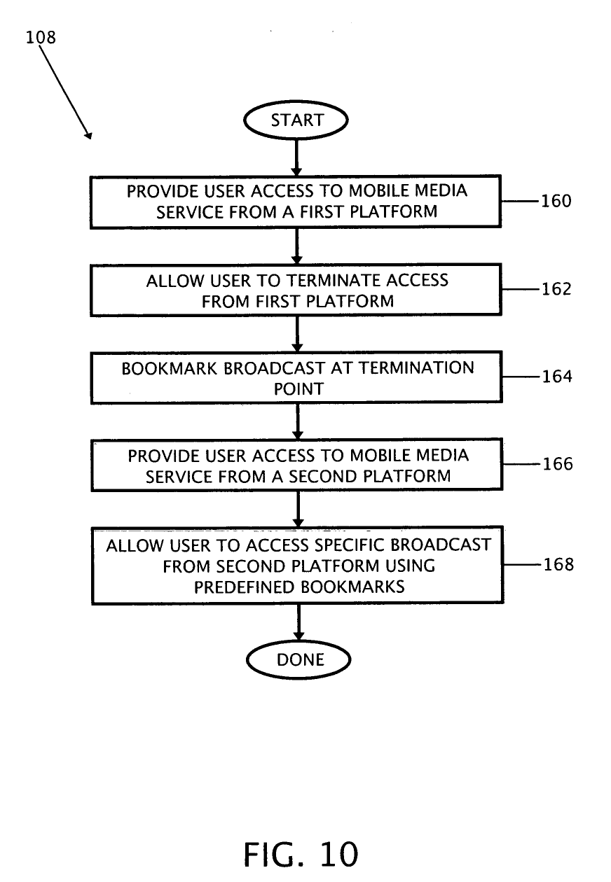

With still further reference to FIG. 7, a step 108 provides users cross-platform access to the broadcast files available through the mobile media server. At step 108 the user is allowed to access the mobile media server through a variety of different platforms and play selected broadcast files such as those established in the user's customized playlist. The present invention contemplates providing access to broadcast files across any suitable platform such as a cellular telephone, a web based browser, a voice over Internet protocol (VOIP) system, a dial in computer connection, etc. Features such as manual and automatic bookmarking, and creating custom playlists, provide users an integrated and coherent media service across multiple platforms including a mobile telephone or other mobile device. One example of how step 108 may be implemented is described below in further detail with reference to FIG. 10.

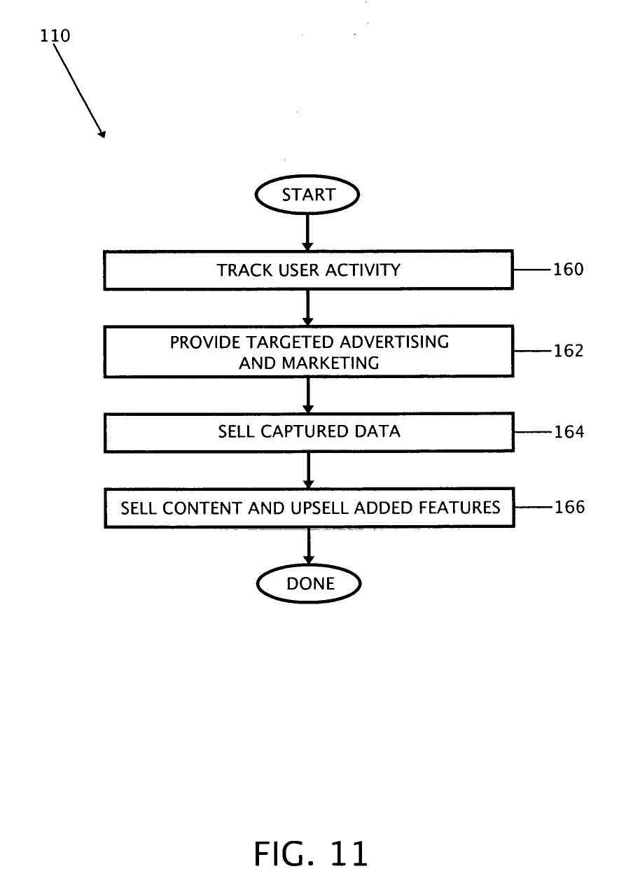

Continuing our description of FIG. 7, a step 110 monetizes the mobile media service. The present invention contemplates a variety of different mechanisms for monetizing the mobile media service. For example, distribution of the broadcast files may be on a paid subscription service, a pay per play service, monetization through advertising and marketing, monetizing user survey participation or other activity of value to third parties, and user viral marketing efforts such as “invite a friend” campaigns. One possible embodiment of a mobile media service that provides free basic service to users is described below with reference to FIG. 11.

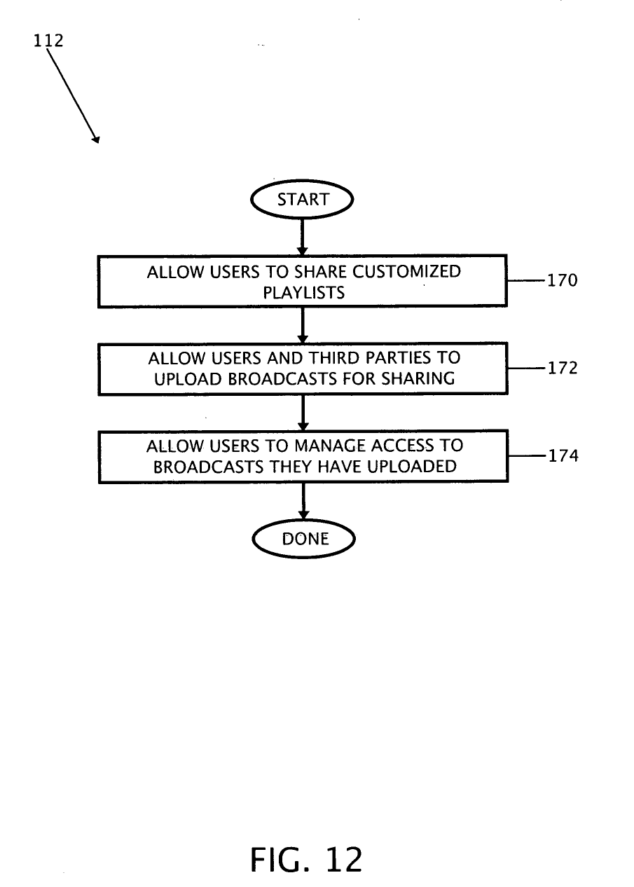

A social networking step 112 of FIG. 7 provides users social networking services in conjunction with and as part of the mobile media service. For example, users may form groups, share customized playlists, upload and share broadcast files, and participate in other well known forms of social networking enhanced through the underlying mobile media service. The social networking may take place across platforms such as mobile devices, cellular telephones, and web based interfaces. One possible implementation of the social networking step 112 is described below with reference to FIG. 12.

As will be appreciated, steps 102-112 of FIG. 7 may be performed in any suitable order, and no step is mandatory to the present invention as they may be performed in various combinations depending upon the desired application.

Turning next to FIG. 8, an embodiment of registration step 102 of FIG. 7 will now be described. An initial registration step 120 receives a registration request from a user. The registration request may arise through any suitable means including a web based interface and a mobile telephone interface. The registration request may occur explicitly or implicitly. In the explicit instance, e.g., the user proactively requests registration. In the implicit case, e.g., the unregistered user may simply access the mobile media service and be registered into the service as a result.

In a telephone capture step 122 of FIG. 8, the mobile media service obtains a primary telephone number of the user, and if desired, multiple telephone numbers may be captured. The mobile media service can immediately recognize an associated user when access originates from the primary telephone number. A step 124 creates a PIN for the user. The PIN is useful for identifying the associated user when access is through an origin that is not associated with any user. In some embodiments, the PIN is selected by the user, in others the mobile media service creates the PIN. A step 126 creates a user password. The password may be used for further identification services, and is an optional requirement depending upon the specific embodiment.

Continuing the description of FIG. 8, an optional monetization step 128 verifies any monetization requirements. The present invention contemplates a variety of monetization techniques such as paid subscription levels, pay per play, support by advertising, marketing, etc. Step 128 may involve taking a user's credit card or other payment information, requiring a user to take other steps such as taking a survey or getting friends to sign up, etc. Once all the required issues of steps 120-128 are completed, a step 130 adds the new user to a user database, and attends to any other required action necessary to complete registration.

Turning to FIG. 9, an embodiment of step 104 of FIG. 7 for creating customized user playlists will now be described. A step 140 provides a user a web interface for working with a mobile media service. A step 142 enables user login to the web based portion of the mobile media service. Login may require PIN, password and PIN, and/or other authentication mechanisms well understood by those in the art. A step 144 allows users to browse the broadcast files available from the mobile media server. The present invention contemplates a wide variety of multimedia files such as audio, video, audiovideo and podcast files. Additionally, the broadcast files may be available for distribution in various formats. For example, a text file may be available for viewing through Internet delivery, and may be transformed into audio format for delivery to a user's telephone. The broadcast files available for browsing by the user may be limited by the user's profile based user age, subscription level, and the like.

In a selection step 146, the user selects broadcast files for later on-demand play. In a verification step 148, the availability of the user selected broadcast files is verified. For example, certain conditions (subscription level, age, format etc.) may preclude the user from adding certain selected broadcasts to their customized playlists. Hence, in certain embodiments the user may be asked to take additional steps before the selected broadcast files are available. Once verification has been completed, a step 150 enables the user to create one or more customized playlists from the selected broadcast files. At this point the user may save the playlists, share playlists, and utilize the playlists later for on-demand play.

Turning next to FIG. 10, one example of coherent and integrated cross-platform access to a mobile media service as mentioned above with reference to step 108 of FIG. 7 will be described. In a first step 160, a user is provided access to the mobile media service on a first platform. The first platform may be an online Internet access portal, a mobile telephone, or such. The user is then allowed to play broadcasts on the first platform, perhaps using a customized playlist or the like. The user may also perform bookmarking and other control functions. In a step 162, the user stops play or perhaps disconnects unintentionally from the mobile media service during the middle of playing a specific broadcast file. As a result of the termination, a step 164 bookmarks the specific broadcast file at the user's termination point, and associates the bookmark with the user. A step 166 provides the user access to the mobile media service from a second platform such as an Internet browser or mobile telephone. A step 168 recalls the users bookmark, including the termination bookmark, and allows the user to begin play of the specific broadcast file on the second platform at the spot where the user terminated play of the specific broadcast file on the first platform. This is one way the user may be provided a coherent and integrated mobile media service across multiple platforms.

Turning next to FIG. 11, a method 110 for monetizing a mobile media service as mentioned above with reference to FIG. 7 will now be described. A step 180 tracks user activity within the mobile media service. For example, the mobile media service could track user listening behavior ranging from content selected, to platform used, and other data. A step 182 can provide targeted marketing and advertising campaigns to the user based on tracked behavior and on personal profile information. A step 184 monetizes the captured information by selling such information to third parties such as marketing companies and retailers. A step 186 provides for the mobile media service to sell content and other goods and services directly to the user.

With reference to FIG. 12, a method 112 for providing social networking services to the user within the mobile media service will now be described. A step 170 enables users to share customized playlists with other users. Customized playlists could also be shared with non-members to improve usability by the users and as a form of viral marketing. A step 172 allows users and/or third parties to upload broadcast files into the mobile media service. The uploaded files could be available to limited groups defined by the user, could be added to the public list of broadcast files, or could be segregated for select consumption via any suitable mechanism. A step 174 allows users to manage access to broadcast files the users have uploaded, allowing the users to selectively distribute broadcast files over which they have control.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A method for providing continuing legal education using a telephone, comprising: receiving a telephone call from a user,
providing a greeting,
prompting said user for a personal identification number,
verifying said personal identification number,
if said personal identification number is not verified,
prompting said user for another personal identification number,
disconnecting after a predetermined number of invalid personal identification numbers,
if said personal identification number is verified,
providing control functions,
providing menu options, said menu options including at least one continuing legal education course lecture,
prompting said user for a menu choice,
beginning said lecture corresponding to menu option chosen by said user,
inserting a bookmark into said lecture if said user disconnects from said lecture or manually requests a bookmark,
ending said lecture,
providing additional information regarding service,
providing a first option for a new lecture,
providing a second option to hang up,
if said first option is chosen, repeating providing menu options and subsequent steps,
if said second option is chosen, hanging up.

2. The method as recited in claim 1, wherein “*” fast forwards said lecture.

3. The method as recited in claim 2, wherein said lecture is advanced by 5 seconds.

4. The method as recited in claim 1, wherein “#” rewinds said lecture.

5. The method as recited in claim 4, wherein said lecture is reversed by 5 seconds.

6. The method as recited in claim 1, wherein “0” pauses said lecture.

7. The method as recited in claim 6, wherein “0” plays said lecture.

8. The method as recited in claim 1, wherein “0” inserts a bookmark into said lecture.

9. The method as recited in claim 1, further comprising:
receiving a second telephone call from said user,
prompting said user for a personal identification number,
verifying said personal identification number;
if said personal identification number is not verified,
prompting said user for a personal identification number until verified,
if said personal identification number is verified,
providing said user with a third option to return to said bookmark,
providing said user with a fourth option to return to beginning of lecture,
if said third option is chosen, starting said lecture at substantially the same time said user disconnected from said lecture,
if said fourth option is chosen, starting said lecture from the beginning of said lecture.

10. A hosted service system comprising:
a centralized server capable of receiving a telephone call and providing at least one menu option to a caller,
a continuing legal education lecture associated with said at least one menu option,
wherein said continuing legal education lecture is played in response to said caller selecting said at least one menu option.

11. A hosted service system as recited in claim 10, wherein said continuing legal education lecture is downloaded to a cell phone in response to a second menu option.

12. A hosted service system as recited in claim 10, wherein said continuing legal education lecture is streamed to a cell phone in response to a second menu option.

13. A hosted service system as recited in claim 10, wherein said caller is tracked for marketing purposes.

14. A hosted service system as recited in claim 10, wherein advertising is provided to said caller.

15. A hosted service system as recited in claim 10, wherein a second menu option provides said caller with an opportunity to purchase materials.

16. A hosted service system as recited in claim 10, wherein said centralized server is capable of receiving a request from the internet and said continuing legal education lecture is streamed over the internet in response to said request.

17. A hosted service system as recited in claim 16, wherein said centralized server is capable of streaming said continuing legal education lecture over the internet in response to said caller selecting a corresponding menu option.

18. A method for receiving continuing legal education, comprising:
calling a centralized server,
providing an authorization code,
selecting a continuing legal education lecture, and
enabling bookmarking with the continuing legal education lecture.

19. A system comprising:
a first module capable of receiving a telephone request for a broadcast file and providing said broadcast file over the telephone, wherein the broadcast file is delivered automatically when the telephone request is from a known user telephone number, and a PIN is required when the telephone request is from an unknown telephone number,
a second module capable of receiving an internet request for a broadcast file and providing said broadcast file over the internet, and
a third module capable of receiving a podcast request for a broadcast file and providing said broadcast file by podcasting.

20. A hosted service system comprising:
a centralized server capable of receiving a request from at least a web based platform and a telephone, and providing at least one menu option to a user,
an audio associated with said at least one menu option,
wherein said audio program is played in response to said user selecting at least one menu option, and
wherein said centralized server is capable of receiving and storing bookmark requests from the user via both said web based platform and said telephone.
